(19) United States
(12) Patent Application Publication
(10) Pub. No.: US 2023/0384513 A1
(43) Pub. Date: Nov. 30, 2023

(54) INCREASING TOTAL DATA CAPACITY IN OPTICAL TRANSMISSION SYSTEMS

(71) Applicant: OFS Fitel, LLC, Norcross, GA (US)

(72) Inventors: David W Peckham, Lawrenceville, GA (US); Durgesh Vaidya, Southbridge, MA (US); Peter A Weimann, Atlanta, GA (US)

(73) Assignee: OFS Fitel, LLC, Norcross, GA (US)

(21) Appl. No.: 18/032,393

(22) PCT Filed: Oct. 18, 2021
(86) PCT No.: PCT/US21/55442

§ 371 Date: Apr. 18, 2023

Related U.S. Application Data
(60) Provisional application No. 63/104,415, filed on Oct. 22, 2020.

(51) Int. Cl. G02B 6/036; G02B 6/44

(52) U.S. Cl. CPC G02B 6/03627; G02B 6/443; G02B 6/4482

(57) ABSTRACT

An optical fiber cable comprises an inner tube with strength members that are located external to, and alongside of, the inner tube. Water-blocking material is also located external to the inner tube. A sheath surrounds the strength members and the water-blocking material. The cable further comprises an optical fiber with a core, a trench surrounding the core, a cladding surrounding the trench, and a coating applied over the cladding. The cable comprises a fiber arrangement with N optical fibers (with N being an integer (e.g., 16, 32, 48, 96, etc.), of which at least one optical fiber has: a maximum effective area (A_{eff}) of approximately seventy-five square micrometers (˜75 μm²) at a wavelength (λ) of approximately 1550 nanometers (˜1550 nm); a maximum mode field diameter (MFD) of ˜8.8 μm at λ of ˜1550 nm; a maximum cable cut-off λ of ˜1520 nm; and, a maximum attenuation of ˜0.180 decibels-per-kilometer (dB/km) at λ of ˜1550 nm.

### CROSS REFERENCE TO RELATED APPLICATIONS

This application claims the benefit of U.S. provisional patent application Ser. No. 63/104,415, filed 2020 Oct. 22, having the title “Reduced Bend-Sensitivity in Fibers and Cabling Configuration,” with first-named inventor David W. Peckham, which is incorporated herein by reference in its entirety.

### BACKGROUND

### Field of the Disclosure

The present disclosure relates generally to fiber optics and, more particularly, to single-mode fibers.

### Description of Related Art

Optical fibers and fiber-optic cables are used extensively in transoceanic submarine data transmission systems. As demand for total data capacity increases, there are corresponding challenges associated with those increasing demands.

### SUMMARY

The present disclosure teaches an optical fiber cable. Briefly described, one embodiment of the optical fiber cable comprises a fiber arrangement with N optical fibers (with N being an integer (e.g., 16, 32, 48, 96, etc.), of which at least one optical fiber has: a maximum effective area (A_{eff}) of approximately seventy-five square micrometers (˜75 μm²) at a wavelength (λ) of approximately 1550 nanometers (˜1550 nm); a maximum mode field diameter (MFD) of ˜8.8 μm at λ of ˜1550 nm; a maximum cable cut-off λ of ˜1520 nm; and, a maximum attenuation of ˜0.180 decibels-per-kilometer (dB/km) at λ of ˜1550 nm.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing a cross-sectional profile for one embodiment of an optical fiber cable.

FIG. 2 is a diagram showing another embodiment of an optical fiber cable.

FIG. 3 is a graph showing a refractive index profile (RIP) for one embodiment of an optical fiber.

FIG. 4 is a graph showing a RIP for another embodiment of an optical fiber.

FIG. 5 is a diagram showing one embodiment of a rollable ribbon.

FIG. 6 is a diagram showing one embodiment of a stack of flat ribbons.

### DETAILED DESCRIPTION OF THE EMBODIMENTS

Conventional wisdom teaches that total data capacity in an optical fiber cable increases with a correspondingly increasing transmission bandwidth of each of the fibers and, also, with increasing optical power for each channel of the optical fibers within the cable. This is because total data capacity of a cable is proportional to the product of the transmission bandwidth of each fiber and the number of fibers in the cable. Furthermore, the data capacity of a fiber is proportional to the available bandwidth and signal power. In other words, if the goal is to increase total data capacity in a fiber-optic cable, then it is both counterintuitive and contrary to conventional wisdom to reduce either transmission bandwidth or reduce per-channel optical power.

However, another factor comes into play in limiting the total data capacity for transoceanic transmission systems. To provide sufficient optical signal power-to-noise ratio for transoceanic submarine transmission systems, undersea repeaters that utilize Erbium-doped fiber optic amplifiers are provided. Semiconductor lasers are used to excite electrons of the Erbium (Er) atoms in the amplifier fiber that provide the gain mechanism of the amplifier. Unfortunately, providing electrical power to energize the lasers in the undersea repeaters is a limiting factor in these types of optical transmission systems. When the transmission bandwidth is increased, the Er amplifiers with matching gain bandwidth are also increasingly more inefficient in utilizing the limited supply of electrical power.

Considering the limited electrical power available, optimum system designs that achieve maximum total data transmission capacity of transoceanic cables often call for less transmission bandwidth per fiber, lower launch power into each transmission channel, and more fibers in the cable. As such, this disclosure provides an approach to increasing total transmission capacity while reducing per-channel transmission bandwidth and per-channel optical power by increasing the total number of optical fibers within the undersea cable. Because of the reduction in per-channel optical power, an approach that maximizes optical fiber effective area (A_{eff}) has limited benefits. In other words, optimization in view of reduced per-channel optical power creates new boundary conditions that cannot be addressed with conventional approaches. Instead, reducing fiber attenuation from both extrinsic and intrinsic sources becomes paramount.

This disclosure teaches a fiber-optic cable having high fiber count ultra-low-loss (ULL) optical fibers with reduced micro-bend sensitivity, which are optimized for use in space-division-multiplexed (SDM) transoceanic submarine systems. Broadly, disclosed is an optical fiber cable with optical fibers that extends along a transmission axis. One or more of the optical fibers has: a maximum A_{eff} of approximately seventy-five square micrometers (˜75 μm²) at a wavelength (λ) of approximately 1550 nanometers (˜1550 nm); a maximum mode field diameter (MFD) of ˜8.8 μm at λ of ˜1550 nm; a maximum cable cut-off λ of ˜1520 nm; and a maximum attenuation of ˜0.180 decibels-per-kilometer (dB/km) at λ of ˜1550 nm. These parameters result in lower micro-bending sensitivity and, therefore, reduced loss when deployed in high-fiber-count cables. Furthermore, these parameters are also consistent with high per-fiber transmission capacity when launching lower per-channel optical power. For some preferred embodiments, the maximum attenuation is as low as ˜0.17 dB/km at λ of ˜1550 nm. In yet other more-preferred embodiments, the maximum attenuation is ˜0.16 dB/km at λ of ˜1550 nm.

To compensate for the reduction in bandwidth of each optical fiber, the optical fibers are configured into a fiber arrangement that increases the total fiber count and, thus, increases the fiber density. For example, the total fiber count for some embodiments can be as high as 32, 48, 96, or more. Although the increased fiber count compensates for the per-channel loss in bandwidth, the increased fiber density also introduces fiber-density-related attenuation, which require careful consideration of factors that are sensitive to both internal and external sources of attenuation. In other words, increasing fiber count is not a simple design choice but, rather, a complicated approach that requires balancing of multiple factors that affect signal attenuation.

Having identified a technical problem and having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

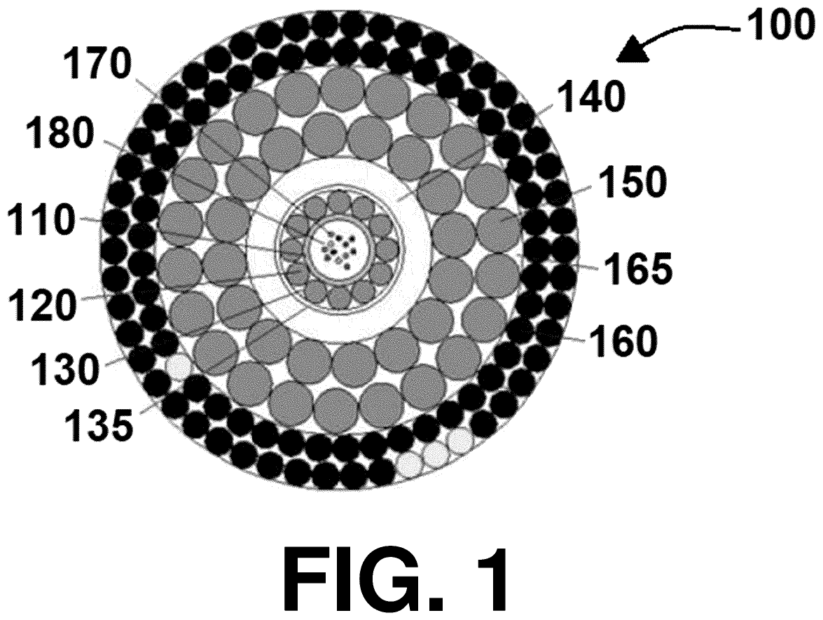

FIG. 1 is a diagram showing a cross-sectional profile for one embodiment of an optical fiber cable 100. The cable comprises an inner tube 110 that extends substantially parallel to a signal-transmission axis. For transoceanic submarine cables, the inner tube 110 is oftentimes an inner metal tube of copper, aluminum, or some other malleable metal. Extending alongside and exterior to the inner tube 110 are strength members 120, such as, for example, armoring steel cables.

Water blocking material 130, such as water-blocking gel is also located external to the inner tube 110 and within spaces between the strength members 120. For some embodiments, the strength members 120 and the water-blocking material 130 are surrounded by water-blocking tape 135, which provides additional protection from any water that is able to intrusively reach inner components of the cable 100.

A sheath 140 (such as a polyethylene sheath) surrounds the strength members 120 and the water-blocking material 130 (and, in the embodiment of FIG. 1, the water-blocking tape 135). For additional strength, the sheath 140 is surrounded by outer armoring steel wires 150, which is held in place by polymer braided rope 160. For some embodiments, fillers 165 occupy spaces between the armoring steel wires 150.

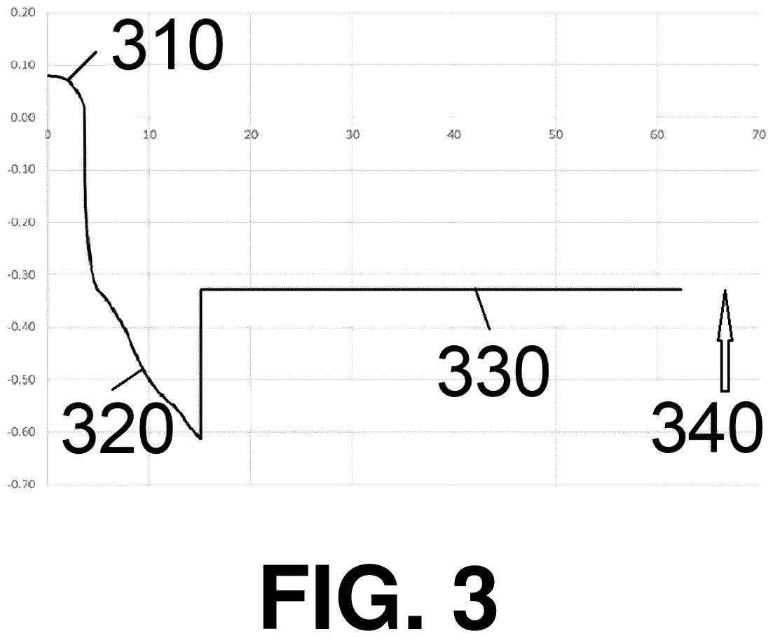

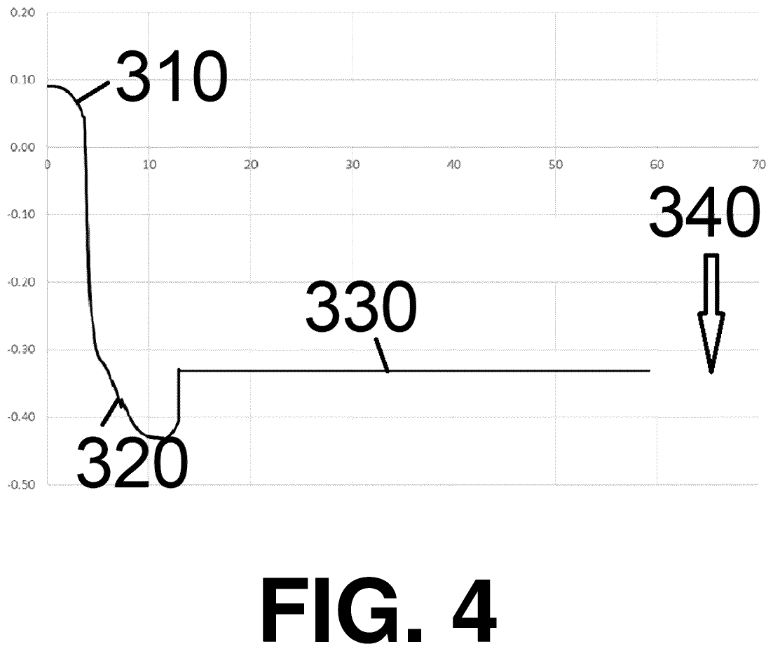

A fiber arrangement with optical fibers 170 is located in the inner tube 110. Preferably, apart from slight modifications described herein for the inventive optical fibers 170, the optical fibers 170 comply with current versions of recommendations from the International Telecommunication Union, Telecommunication Standardization Sector (ITU-T), Series G: Transmission Systems and Media, Digital Systems and Networks, setting forth transmission media and optical systems characteristics for optical fibre cables. The ITU-T, Series G.657 standard is designated herein as ITU-T G.657, further sub-part designations being denoted as A1, A2, etc. (e.g., ITU-T G.657.A1, ITU-T G.657.A2, etc.). Because those having ordinary skill in the art are familiar with the ITU-T G.657 standards, which set forth the characteristics of a bending-loss insensitive single-mode optical fibre and cable, only a truncated discussion of the ITU-T standards is provided herein. For clarity, example refractive index profiles (RIPs) of some embodiments of optical fibers 170 are shown with reference to FIGS. 3 and 4, which are discussed in greater detail, below.

Continuing with FIG. 1, as one can appreciate, the fiber arrangement creates interstitial spaces. To manage any water that might intrude into the inner tube 110, water-blocking gel 180 also occupies portions within the inner tube 110 to provide further protection to the optical fibers 170.

As noted above, because lower transmission bandwidth on each fiber and per-channel power is used, an increased total cable bandwidth is achieved by configuring the fiber-optic cable with sufficiently high number of fibers at a high fiber density. However, as fiber counts increase, identification of individual fibers becomes an increasingly difficult challenge. In a transoceanic fiber optic cable system, fibers across several different cables are spliced together to create continuous optical channels connecting each end. At each splice point or cable end it is necessary for the installer to uniquely identify each individual fiber to ensure proper connection.

In traditional lower fiber count transoceanic systems, this can be facilitated by applying a thin layer of UV-cured coloring ink to each fiber. The Telecommunications Industry Association (TIA) standard TIA-598-D.1, Optical Fiber Cable Color Coding, defines sixteen (16) colors for individual fiber identification. In sequence, these are blue, orange, green, brown, slate (gray), white, red, black, yellow, violet, rose (pink), aqua (turquoise), olive, tan, magenta and lime green. It is possible to create several more colors beyond these 16 that can be distinguished by the human eye, but it becomes difficult to associate each of these with a unique name. One solution to this problem that is known in the art is “ring marking” of fibers, in which an ink-jet printed mark is periodically applied to a fiber. For example, a blue fiber with one ring repeated at a regular distance identifies fiber Number 17, an orange fiber with one ring is fiber Number 18, and a blue fiber with two rings repeated regularly identifies fiber Number 33, and so on. Unfortunately, ring marking is a slow and expensive process, and alternative methods for individual fiber identification are desirable.

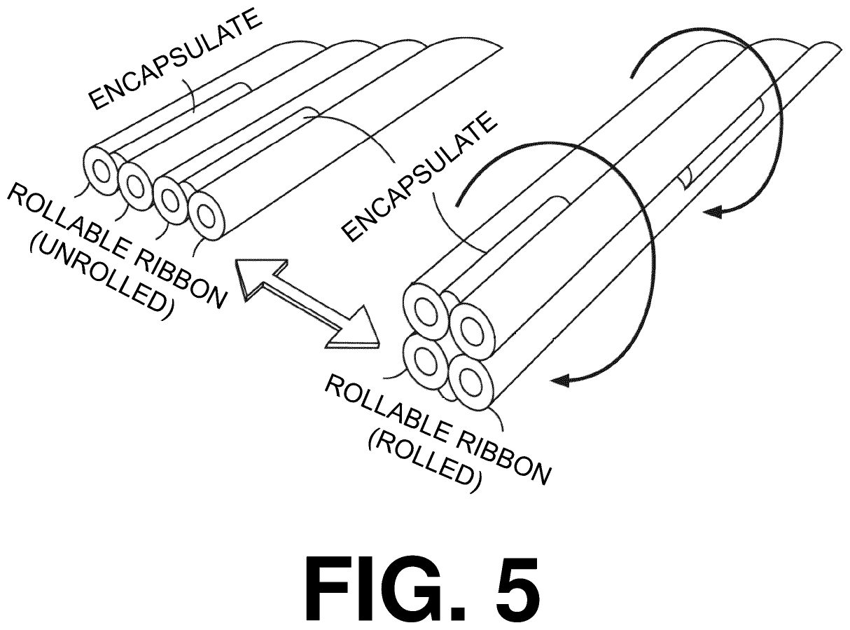

In one embodiment, a sufficiently high fiber density (or fiber count) is achieved by using a rollable ribbon, such as that shown in FIG. 5. For illustrative purposes only, an example of a rollable ribbon is shown in U.S. patent application Ser. No. 16/929,209, filed on 2020 Jul. 15, having the title “Optical Fiber Coatings,” by Konstadinidis (“Konstadinidis”), which is incorporated by reference in its entirety as if set forth expressly herein. Although a four (4) fiber embodiment is shown FIG. 5 and in Konstadinidis, it should be appreciated that a rollable ribbon can be manufactured with a higher integer (N) fiber count. Rollable ribbons with 8, 12, 16 or 24 fibers are all known in the art. Individual rollable ribbons can be readily identified by either varying the color sequence within the ribbon, or by applying a printed mark to each ribbon using an ink-jet printer or similar method. Deployment of multiple rollable ribbons within a high fiber count cable can therefore provide a beneficial means of individual fiber identification. However, for such high fiber counts, factors that affect fiber attenuation should be carefully considered.

To be clear, although it is possible to have a single rollable ribbon with an extremely high fiber count, a more-preferable implementation is to organize multiple rollable ribbons so that each rollable ribbon has a lower fiber count but the aggregate of all of the rollable ribbons has an extremely high fiber count. For example, rather than having a single rollable ribbon with 48 fibers, a more-preferred approach is to have six (6) rollable ribbons with eight (8) fibers each, thereby resulting in the same total of 48 fibers.

By placing multiple rollable ribbons in the inner (or central) tube, a high number of unique fiber colors is no longer necessary to uniquely identify the fibers. For example, a blue-colored fiber in the first ribbon can be differentiated from a blue-colored fiber in the second ribbon, as long as the respective location of the blue-colored fibers in the ribbons is different between the two ribbons.

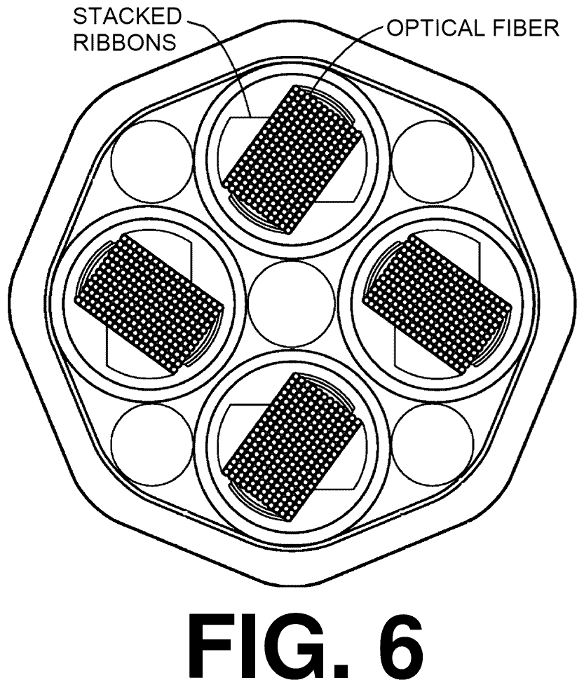

In another embodiment, a sufficiently high fiber count (or fiber density) is achieved by using stacks of flat ribbons, such as that shown in FIG. 6. It should be appreciated that, although the cable of FIG. 6 may not be a submarine cable, the stacks of flat ribbons are equally applicable for transoceanic submarine cables as they are for other types of cables. For illustrative purposes only, example flat ribbon stacks are shown in U.S. patent application Ser. Nos. 15/216,780 and 15/216,807, both filed on 2016 Jul. 22, having the title “Optical Fiber Cable,” by Debban (“Debban1” and “Debban2,” respectively), which are incorporated by reference in their entireties as if set forth expressly herein. As one can appreciate, high fiber counts of N=16, N=32, N=48, or even N=96 can be positioned in the inner tube 110 using flat ribbons. Variation of the color sequence within a ribbon or printed identification marks on each ribbon can enable identification of individual fibers. Again, for such high fiber counts, one should carefully consider the factors that affect fiber attenuation.

It should be appreciated that, for other embodiments, high fiber counts are achievable with multiple color-coded fiber bundles, multiple two-fiber ribbons, or any combination of rollable ribbons, flat ribbons, fiber bundles, multiple two-fiber ribbons, or other known configurations that support high fiber counts (e.g., N=16, 32, 48, 96, etc.). Because those having skill in the art are familiar with rollable ribbons, flat ribbons, and fiber bundles, only truncated discussions of those configurations are provided herein.

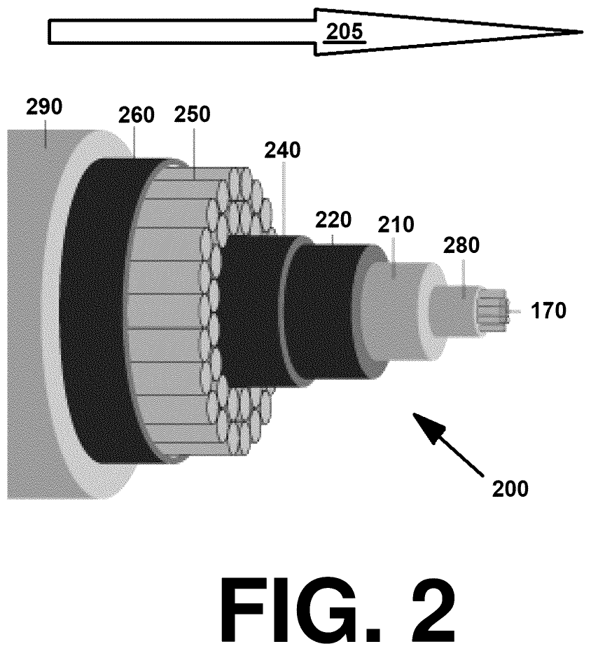

Continuing to FIG. 2, another embodiment of an optical fiber cable 200 is shown. To better illustrate the alignment of components, a transmission axis 205 is designated from left to right. As shown in FIG. 2, this embodiment of the optical fiber cable 200 also comprises an inner tube 210 (also called a buffer tube in other embodiments, or a fiber inner metal tube (FIMT) for still other embodiments). The inner tube 210 extends substantially parallel to the transmission axis 205.

A strength member 220 is located external to the inner tube 210. In FIG. 2, the strength member 220 is shown as a polycarbonate member that extends alongside the inner tube 210, with a sheath 240 surrounding the strength member 220. The sheath 240 also extends substantially parallel to the transmission axis 205.

Outer armoring, such as stranded steel wires 250, surround the sheath 240 and provide strength for the fiber-optic cable 210. Mylar tape 260 surrounds the stranded steel wires 250, which, in turn, are surrounded by a polyethylene outer jacket 290. Also extending along the transmission axis 205 are optical fibers 170, which are located within the inner tube 210 and surrounded by water-blocking gel 280. Preferably, the optical fibers 170 comply with ITU-T G.657.A1 and ITU-T G.657.A2 standards, which are familiar to those having skill in the art and, also, discussed above.

Having discussed the inner components of example optical fiber cables, attention is turned to FIG. 3 and FIG. 4, which show graphs of refractive index profiles (RIPs) for several embodiments of optical fibers that provide a suitable balance between total data bandwidth and per-channel power.

As shown in FIGS. 3 and 4, the optical fiber 170 comprises a core 310 having a core radius (r_{core}) and has an up-doped core refractive index (n_{core}). Typically, the core 170 comprises dopants, such as, approximately a thousand parts-per-million (˜1,000 ppm) to ˜18,000 ppm of chlorine (Cl), approximately 0 to 0.5 weight percent (˜0.5 wt %) of fluorine (F), up to ˜200 ppm an alkali metal (e.g., lithium (Li), sodium (Na), potassium (K), etc.), or any combination thereof. The alkali metals typically diffuse either radially outward or radially inward (depending on the initial location of the dopants) at high temperatures, such as during core-rod-stretching processes, trench-deposition processes, cladding-deposition processes, or fiber-draw processes.

For the particular embodiment of FIG. 3, the optical fiber 170 has a r_{core} of approximately 3.62 micrometers (meaning, r_{core}=3.62 μm). It should be appreciated that, although FIG. 3 shows r_{core} being less than ˜4 μm, other embodiments contemplate a r_{core} being up to ˜4 μm or, sometimes, greater than ˜4 μm.

Radially exterior to the core 310 is a trench 320, which has a trench outer radius (r_{trench}) and is down-doped to a trench refractive index (n_{trench}), with n_{core} being greater than n_{trench} (namely, n_{core}>n_{trench}). The trench 320 often comprises F-dopants up to ˜2.5 wt % and, possibly, alkali metals (e.g., Li, Na, K, or combinations thereof, etc.) that have diffused into the trench 320 from the core 310 through the core-trench boundary. For some embodiments, r_{trench} is approximately four (4) times r_{core} (meaning, r_{trench}=4*r_{core}). However, it should be appreciated that other embodiments comprise r_{trench} as high as r_{trench}=4.1*r_{core} or as low as r_{trench}=3.6*r_{core}.

The optical fiber 170 also comprises a cladding 330 that is located radially exterior to the trench 320, with the cladding having an outer cladding radius (r_{clad}) and a cladding refractive index (n_{clad}), with n_{clad} being higher than n_{trench} but lower than n_{core}(meaning, n_{core}>n_{clad}>n_{trench}). Often, the cladding 330 comprises an F-dopant to change the refractive index and the viscosity so that the delta in the cladding 330 is approximately negative 0.33 percent (˜−0.33%), or somewhere between −0.3% and −0.4%. Preferably, r_{clad}=62.5 μm.

Typically, a coating 340 is located radially exterior to the cladding 330, thereby giving the optical fiber 170 a fiber diameter that is determined by the coating diameter (d_{coat}). Preferably, d_{coat} is less than −125 μm (meaning, d_{coat}<−125 μm) and, more preferably, d_{coat}<˜100 μm or even d_{coat}<˜80 μm. Such small d_{coat} values provide greater fiber densities without compromising the desirable fiber transmission properties.

With these parameters, the optical fiber 170 exhibits properties that permit higher total system capacity. For example, the disclosed optical fiber 170 has a maximum effective area (A_{eff}) of between ˜78 μm² and ˜80 μm² (preferably, lower than 75 μm²) at a wavelength (λ) of ˜1550 nm, a maximum mode field diameter (MFD) of ˜8.8 μm at λ of ˜1550 nm, a maximum cable cut-off λ of ˜1520 nm, and a maximum attenuation of ˜0.180 decibels-per-kilometer (dB/km) at λ of ˜1550 nm. As shown from these properties, the optical fiber 170 exhibits low sensitivity to micro-bending induced excess fiber loss. The low micro-bending sensitivity supports high total transmission capacity even when the constraint on electrical power results in lower per-channel optical power by permitting higher fiber density in the cable. The per-fiber reduction in capacity resulting from lower per-channel launch power and narrower per fiber transmission bandwidth is offset by higher fiber counts in the cable, thereby providing an overall increase in total data capacity. Furthermore, these fiber properties provide decreased sensitivity to bend-induced excess losses, thus helping to maintain the low fiber loss when the fiber is deployed in high density, high-fiber-count cables. Additionally, judicious selection of d_{coat} allows for a balance between bend sensitivity and fiber density.

Restating one of the primary problems, micro-bending losses in single-mode fibers (SMFs) result from coupling energy out of the fundamental mode and into higher order modes that are generally very lossy. Micro-bending mode coupling occurs when external forces result in axially varying perturbations of the waveguide, generally in the form of deflections in the fiber axis or distortions to the index profile through photo-elastic effects. In addition to the overlap between the electric fields of the fundamental modes and higher-order modes, another significant factor is the difference in longitudinal propagation constants between the fundamental mode and the higher-order modes. Both the overlap in electric fields and the difference in propagation constants are influenced by waveguide design. As shown above, the bend-sensitivity of an optical fiber 170 is improvable through reductions in the MFD of the fundamental mode, which reduces modal overlap. Since A_{eff} is generally a function of the square of the MFD, a reduction in the fundamental mode MFD correspondingly reduces the A_{eff}.

In the past, conventional submarine systems increased data transmission capacity by maximizing the transmission capacity of each individual fiber within the cable, with the optimum fiber being one with the largest A_{eff}. Unfortunately, micro-bend sensitivity increased with an increasing A_{eff}. For example, when A_{eff}>130 μm², bend sensitivity sometimes increased by a factor of twenty (20) or more, as compared to bend-insensitive (BI) fiber designs. Because of such large increases in bend sensitivity, larger-than-standard coating diameters were tolerated to compensate for the unacceptable increases in bend sensitivity. These larger-than-standard coating diameters required correspondingly low fiber densities, thereby limiting conventional submarine cables to fiber counts that were lower than sixteen (16).

One approach to increasing fiber counts is to increase the inner dimension of the inner tube (or central tube or buffer tube). Unfortunately, such an increase in inner-tube size requires a new cable design with increased costs, increased resources for re-design, new efforts to qualify the cable, ensure reliability of repeaters at cable entry points, standardization issues, repair costs, and a host of other problems that accompany a cable re-design. Furthermore, the increase in dimensions also causes an increase in extrinsic forces on the cable. At bottom, substantial increases to the inner tube dimensions become impractical at some point.

The embodiments of FIGS. 1 through 4 allow for improved BI while, at the same time, also allowing for higher fiber densities. At λ of ˜1550 nm, and with all relevant dimensions being comparable, some embodiments of the disclosed fibers exhibit micro-bend sensitivities that are less than ˜0.75 times that of conventional ultra-low-loss (ULL) single-mode fibers (SMF) having MFD of ˜9.2 μm. Other embodiments exhibit micro-bend sensitivities that are less than ˜0.5 times that of conventional ULL-SMF (with all relevant dimensions being comparable).

Another problem that arises from an increased fiber count is difficulty in identifying individual fibers, which can be seen as the problem of finding a proverbial needle in a haystack. One option of identifying each individual fiber is by implementing a color-coding scheme, for example, based on the Telecommunications Industry Association (TIA) standard TIA-598-D.1, Optical Fiber Cable Color Coding, which is familiar to those having skill in the art. TIA-598 defines either twelve (12) or sixteen (16) standard colors and recommends using dashes or marks to identify fibers beyond the initial 12 or 16 standard colors. However, common technologies for implementing dashes or marks are relatively slow and can affect signal attenuation. Thus, although it is possible in theory to identify numerous individual fibers within a high-fiber-count cable (e.g., 48 fiber cable, 96 fiber cable, etc.)), it is difficult in practice and not readily implementable without significant cost.

Rather than color-coding individual fibers, this disclosure teaches grouping or bundling of fibers. As discussed with reference to FIGS. 1 and 2, a fiber arrangement (e.g., rollable ribbon, flat ribbon stacks, color-coded bundles, two-fiber ribbons, and combinations thereof, etc.) allow for easier differentiation of fibers. Individual rollable or flat ribbons may be readily identified by varying the color sequence within each ribbon, or alternately by applying a unique printed mark to each ribbon. Bundles of fibers may be uniquely identified through the use of color-coded threads to group fibers in each bundle.

By way of example, organizing fibers in flat ribbons of, for example, two (2), four (4), six (6), eight (8), twelve (12), or sixteen (16) fibers permits stacking of the ribbons into rectangular stacks, which can then be placed into the inner tube. The stacked ribbons are more space efficient than loose fibers, thereby permitting much higher fiber densities within the inner tube.

Also, organizing fibers into two-ribbon groups allows for color-coding of base-pairs, rather than color-coding of individual fibers. Thus, the combination of colors in each pair increases the number of identifying color combinations exponentially (by a power of two).

It is known in the art that fibers grouped into ribbons or bundles generally have higher cabled signal attenuation than equivalent loose individual fibers. This is because grouping the fibers into ribbons or bundles limits the ability of each individual fiber to relax to its lowest-energy state and can lock fibers into configurations that cause micro-bending loss. Use of an inherently trench-assisted fiber with a low A_{eff} can partially or fully compensate for these effects.

Although exemplary embodiments have been shown and described, it will be clear to those of ordinary skill in the art that a number of changes, modifications, or alterations to the disclosure as described may be made. For example, although FIGS. 1 through 4 provide specific numerical parameters for preferred embodiments of a bend-insensitive (BI), ultra-low-loss (ULL), single-mode fiber (SMF), it should be appreciated by those having skill in the art that different numerical parameters can be implemented. For example, a BI-ULL-SMF fiber with a nominal coating diameter (d_{coat}) of: d_{coat}=245 μm, ˜205 μm<d_{coat}<˜240 μm (e.g., d_{coat}=220 μm); or d_{coat}<˜200 μm (e.g., d_{coat}=190 μm, d_{coat}=180 μm, d_{coat}=170 μm, d_{coat}=160 μm, etc.). For other embodiments, a nominal cladding diameter (d_{clad} (which is 2*r_{clad})) of d_{clad}<˜125 μm. In yet other embodiments, different combinations, such as: d_{clad}≥˜125 μm with d_{coat}≤˜245 μm; and so on. All such changes, modifications, and alterations should therefore be seen as within the scope of the disclosure.

What is claimed is:

1. An optical fiber cable, comprising:
a transmission axis;
an inner tube extending substantially parallel to the transmission axis;
strength members located external to the inner tube, the strength members extending alongside the inner tube;
water-blocking material located external to the inner tube;
a sheath surrounding the strength members, the sheath further surrounding the water-blocking material, the sheath extending substantially parallel to the transmission axis;
an optical fiber extending along the transmission axis, the optical fiber comprising:
a core comprising a core radius (r_{core}), the core further comprising a core refractive index (n_{core});
a trench located radially exterior to the core, the trench comprising a trench outer radius (r_{trench}), the trench further comprising a trench refractive index (n_{trench}), n_{trench} being lower than n_{core};
a cladding located radially exterior to the trench, the cladding comprising a cladding outer radius (r_{clad}), the cladding further comprising a cladding refractive index (n_{clad}), n_{clad} being higher than n_{trench}, n_{clad} being lower than n_{core};
a coating located radially exterior to the cladding, the coating comprising a coating diameter (d_{coat});
a maximum effective area (A_{eff}) of approximately seventy-five square micrometers (˜75 μm²) at a wavelength (λ) of approximately 1550 nanometers (˜1550 nm);
a maximum mode field diameter (MFD) of ˜8.8 μm at λ of ˜1550 nm;
a maximum cable cut-off λ of ˜1520 nm; and
a maximum attenuation selected from the group consisting of:
approximately 0.180 decibels-per-kilometer (dB/km) at λ of ˜1550 nm;
approximately 0.170 dB/km at λ of ˜1550 nm;
approximately 0.160 dB/km at λ of ˜1550 nm; and
a fiber arrangement located within the inner tube, the fiber arrangement comprising the optical fiber.

2. The cable of claim 1, r_{trench} being approximately four times greater than r_{core} (r_{trench}=4*r_{core}).

3. The cable of claim 1, r_{trench}=4.1*r_{core}.

4. The cable of claim 1, r_{trench}=3.6*r_{core}.

5. The cable of claim 1, the fiber arrangement being selected from the group consisting of:
rollable ribbons;
color-coded fiber bundles;
flat ribbons;
two-fiber ribbons; and
a combination thereof.

6. The cable of claim 1, further comprising:
interstitial space within the inner tube; and
water-blocking gel located in the interstitial space, the water-blocking gel surrounding the fiber arrangement.

7. The cable of claim 1, r_{core} being ˜4 μm.

8. The cable of claim 1, r_{core} being less than ˜4 μm.

9. The cable of claim 1, the core comprising a dopant, the dopant being selected from the group consisting of:
between approximately 1,000 parts-per-million (˜1,000 ppm) chlorine (Cl) to 4-18,000 ppm Cl;
up to approximately 0.5 weight percent (˜0.5 wt %) fluorine (F);
lithium (Li);
sodium (Na);
potassium (K); and
any combination thereof.

10. The cable of claim 1, the trench comprising up to approximately 2.5 weight percent (˜2.5 wt %) fluorine (F).

11. The cable of claim 10, the trench further comprising an alkali metal selected from the group consisting of:
lithium (Li);
sodium (Na);
potassium (K); and
any combination thereof.

12. The cable of claim 1, the cladding comprising a fluorine (F) dopant.

13. The cable of claim 1, r_{clad} being ˜62.5 μm.

14. The cable of claim 13, r_{clad} being less than ˜100 μm.

15. The cable of claim 1, the d_{coat} being less than ˜125 μm.

16. The cable of claim 15, the d_{coat} being less than ˜100 μm.

17. The cable of claim 15, the d_{coat} being less than ˜80 μm.

18. The cable of claim 1, the optical fiber further comprising a macro-bend sensitivity that complies with an industry standard selected from the group consisting of:
International Telecommunication Union, Telecommunication Standardization Sector, Series G.657.A1 (ITU-T G.657.A1); and
ITU-T G.657.A2.

19. The cable of claim 1, the fiber arrangement comprising N total transmission optical fibers, N being an integer.

20. The cable of claim 19, N being one selected from the group consisting of:
32;
48; and
96.
